(19) United States
(12) Patent Application Publication
(10) Pub. No.: US 2008/0108432 A1
(43) Pub. Date: May 8, 2008

(54) INTELLIGENT AD INTEGRATION FOR VIDEO GAMING

(75) Inventors: Gabriel A. Cohen, Durham, NC (US); William G. Pagan, Durham, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/556,857

(22) Filed: Nov. 6, 2006

(51) Int. Cl. G06F 17/00

(52) U.S. Cl. 463/32; 463/29; 463/43

(57) ABSTRACT

Embodiments of the invention address deficiencies of the art in respect to embedded ad placements and provide a novel and non-obvious method, system and computer program product for intelligent ad placements for video gaming. In one embodiment of the invention, a method for intelligent ad integration for video gaming can be provided. The method can include monitoring a video game supported by computing resources to detect events in the video game, measuring performance of the computing resources in the detected events, associating advertisements with the events based upon the measured performance of the computing resources for the detected events, and presenting the associated advertisements in association with the video game. Notably, monitoring a video game to detect events in the video game can include monitoring user activities, game activities, and computing environment attributes to detect events related to user actions, game actions and computing environment attributes, respectively, in the video game.

### BACKGROUND OF THE INVENTION

1. Field of the Invention

The present invention relates to the field of electronic ad placement and more particularly to electronic ad placement for video gaming.

2. Description of the Related Art

Electronic ad placement refers to the embedding of advertisements in a user interface for a computer program. Electronic ad placement first become popularized through the distribution of demo-ware in which advertisements to purchase a full and unfettered version of a computer program from a demonstration version of the computer program were placed in the user interface for the demonstration version. Later, software publishers embedded advertisements for a computer program within the user interface of a related or companion computer program, both published by the same publisher. Even further variants of electronic ad placement included the embedding of advertisements of related programs published by different publishers through a joint marketing arrangement.

The advent of the Internet has accelerated the growth and sophistication of electronic ad placements. Modern ad placement engines support the embedding of multiple advertisements in a single user interface and the periodic variation of ads in a user interface in order to provide a sense of liveness to the advertisements. Mostly associated with the Web pages of the Internet, an enormous industry has evolved in the form of search engine companies through embedding electronic ads in the Web pages of customers, whether or not the embedded ads relate specifically to the content of the Web pages.

Advanced forms of electronic ad placements sense user interactions with Web pages and Web based information portals in order to identify pertinent ads for display through a Web page. One contemporary ad placement technology monitors search terms provided by an end user interacting with a search engine in order to generate a set of embedded electronic ads most pertinent to the search terms provided by the user. This form of targeted advertising has proven extraordinarily popular as the embedded ads directly relate to the actions of the intended viewer of the embedded ads.

The correspondence of end user activities to embedded electronic ads has largely been limited to the search engine space. Notwithstanding, end users utilize many applications aside from search engines on a daily basis. As such, the majority of interactive computing activities of end users largely remains untracked and unnoticed. Therefore, marketers have largely ignored opportunities for intelligent ad placement in applications other than search engines and Web based information portals.

### BRIEF SUMMARY OF THE INVENTION

Embodiments of the invention address deficiencies of the art in respect to embedded ad placements and provide a novel and non-obvious method, system and computer program product for intelligent ad placements for video gaming. In one embodiment of the invention, a method for intelligent ad integration for video gaming can be provided. The method can include monitoring a video game supported by computing resources to detect events in the video game, associating advertisements with the events based upon the monitored performance, and presenting the associated advertisements in association with the video game. Notably, monitoring a video game to detect events in the video game can include monitoring user activities, game activities, and computing environment attributes to detect events related to user actions, game actions and computing environment attributes, respectively, in the video game.

In another embodiment of the invention, a video game data processing system can be provided. The system can include a video game, intelligent ad placement logic coupled to the video game, and ads mapped to corresponding monitored performance for detectable events able to occur in the video game. The events can include user activities, game activities and computing environment attributes. In one aspect of the embodiment, the video game and the intelligent ad placement logic can be disposed in a host computing platform. In another aspect of the embodiment, the video game can be disposed in a host computing platform coupled to a server computing platform hosting the intelligent ad placement logic.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustrating of a video gaming data processing system configured for intelligent ad placement; and,

FIG. 2 is a flow chart illustrating a process for intelligent ad placement for video gaming.

### DETAILED DESCRIPTION OF THE INVENTION

Embodiments of the invention provide a method, system and computer program product for intelligent ad placement for video gaming. In accordance with an embodiment of the present invention, the operation of a video game can be monitored for pre-selected events. The pre-selected events can include user activity, game activity, and computing environment activity related events. A set of ad placements can be mapped to the pre-selected events. Thereafter, responsive to the detection of a pre-selected event, a mapped ad placement can be applied to the user interface of the video game. In this way, the ad placement can be intelligently related to the contemporary use of the video game and can enjoy a high degree of relevance to the end user experience in the video game.

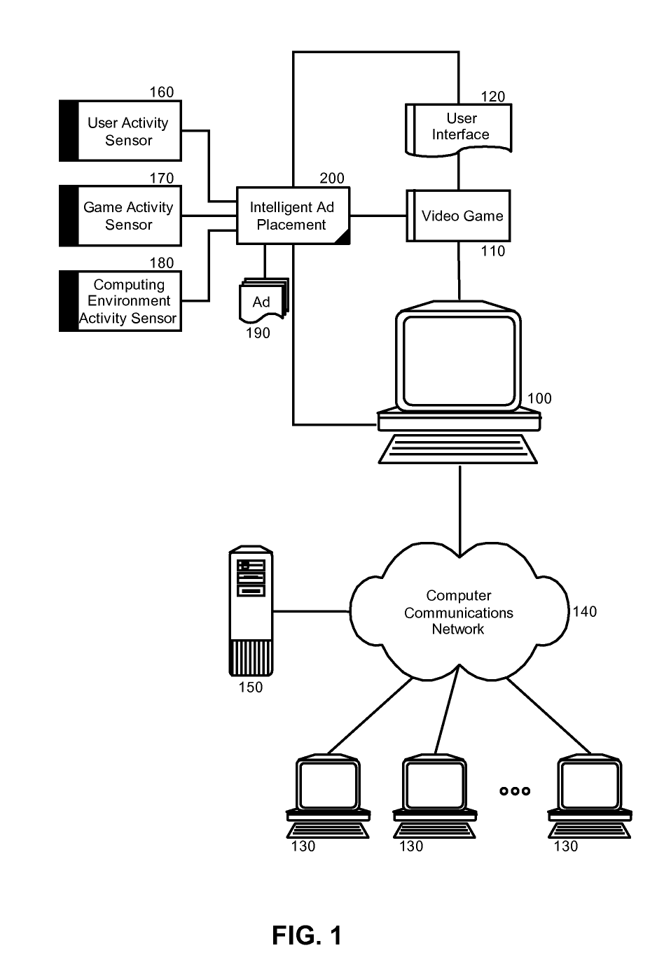

In further illustration, FIG. 1 is a schematic illustrating of a video gaming data processing system configured for intelligent ad placement. The video gaming system can include a host computing platform 100 supporting the operation of a video game 110 having a user interface 120. Of note, the user interface 120 can include a visually perceptible user interface, an audibly perceptible user interface, or an audio-visually perceptible user interface. The video gaming system can be a stand-alone gaming system, or a networked gaming system. In the latter circumstance, the host computing platform 100 can be coupled to one or more other gaming platform hosts 130 over a computer communications network 140.

Intelligent ad placement logic 200 can be coupled to the video game 110. The intelligent ad placement logic 200 can include each of a user activity sensor 160, a game activity sensor 170 and a computing environment activity sensor 180. The user activity sensor 160 can be configured to detect and log user actions in the video game 110 such as the movement of a character in the video game 110 performed by the user, or the use of weaponry by the user in the video game 110. In addition, the user actions can include detailed metrics relating to the movement of the character and the use of weaponry, including any latencies in the physical input of a command and the response in the video game 110.

The game activity sensor 170, by comparison, can be configured to detect and log game actions such as when a user wins or loses, acquires electronic game articles, and when the user is struck by a weapon and when a character controlled by the user becomes disabled or killed. Finally, the computing environment activity sensor 180 can be configured to detect and log environmental attributes relating to the computing environment established by the host computing platform 100 in support of the video game 110. The attributes can include, by way of example, network responsiveness, memory usage and constraints, display resolution and size, video card performance, input device performance and the like.

The intelligent ad placement logic 200 can include program code enabled to receive events from the sensors 160, 170, 180. The program code can be further enabled to process each received event in order to map the received event to one or more ads 190 associated with the received event. In this regard, the mapping can indicate the placement of an ad in response to the detection of a particular event, or the mapping can indicate the placement of an ad in response to the repeated detection of the same event or events past a threshold value. Finally, the intelligent ad placement logic 200 can be yet further enabled to embed a mapped ad into the user interface 120 of the video game 110, or to launch a separate user interface incorporating the mapped ad in addition the user interface 120 of the video game 110.

Notably, the skilled artisan will recognize that although the intelligent ad placement logic 200 is shown to be coupled to the video game 110 from within the host computing device 100, in a distributed implementation, the intelligent ad placement logic 200 can be disposed in a server computing platform 150 coupled to the computer communications network 140. In this instance, the ads 190 can be updated periodically from a publishing source (not shown) in the computer communications network 140 and events can be processed as received from reporting agents in each of the gaming platform hosts 130.

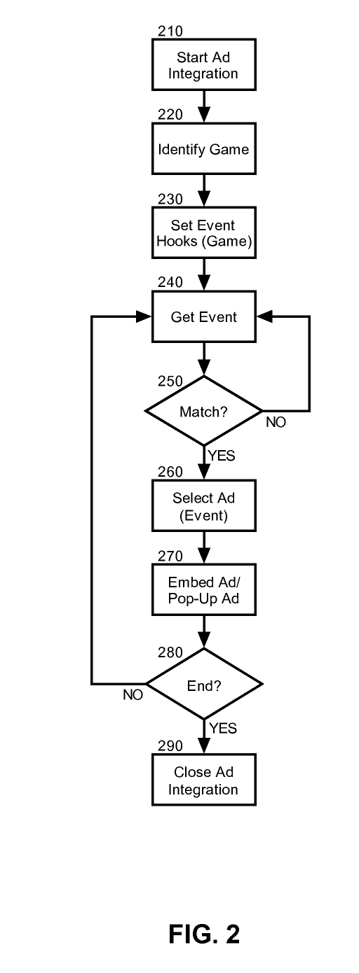

Turning now to FIG. 2, a flow chart is shown which illustrates a process for intelligent ad placement for video gaming. Beginning in block 210, the ad placement logic can be launched and in block 220, a game can be identified for integration with the ad placement logic. In block 230, at least one event hook can be set for detecting an event occurring in the game. For instance, the event hooks can trap events such as when a character controlled by a use “dies”, when a weapon applied by a user fails to strike its target in a timely manner, and when a weapon not visible to the user in a user interface for the game affects a character controlled by the user, to name only a few examples.

In block 240, an event can be received from the game. In decision block 250 if the event maps to an advertisement, in block 260, the mapped advertisement can be selected for placement in association with the user interface for the video game and in block 270, the selected advertisement can be associated with the user interface for the video game. In this regard, the selected advertisement can be embedded in the user interface for the video game in the form of a distinct advertisement, or in the form of a change to the features and characteristics of the user interface. Alternatively, the selected advertisement can be placed in a separate user interface and rendered in association with the user interface for the game. In either case, in decision block 280, if the game has not ended, the process can repeat through block 240. When the game does end, in block 290, the ad integration logic can be terminated.

Exemplary uses of the foregoing process are as follows:

1. When the character operated by the end user is struck by a projectile emanating from an object in the video game not viewable by the end user due to constrained display parameters, an advertisement for an improved display card can be presented to the end user.

### 2. When the end user commands the use of weaponry through an input device such as a joystick, but is unable to achieve above a predetermined hit percentage, an advertisement can be selected for an improved input device.

### 3. When the end user commands an operation in the video game and the network latencies cause the command to be sluggishly performed, an advertisement for a different, improved network access provider or service can be selected.

### 4. When the computing environment for a companion gamer exceeds that of the end user, advertisements for the differentiating components can be selected so as to entice the end user to purchase the products used by the companion gamer.

### It will be recognized by the skilled artisan, however, that the foregoing enumerated examples are merely examples and are not limiting in any way as to the numerous other scenarios afforded by the invention as claimed herein.

The embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for intelligent ad integration for video gaming, the method comprising:
monitoring a video game supported by computing resources in order to detect events in the video game;
measuring performance of the computing resources in the detected events;
associating advertisements with the events based upon the measured performance for the detected events; and,
presenting the associated advertisements in association with the video game.

2. The method of claim 1, wherein monitoring a video game supported by computing resources in order to detect events in the video game, comprises monitoring user activities to detect events related to user actions in the video game.

3. The method of claim 1, wherein monitoring a video game supported by computing resources in order to detect events in the video game, comprises monitoring game activities to detect events related to game actions in the video game.

4. The method of claim 1, wherein monitoring a video game supported by computing resources in order to detect events in the video game, comprises monitoring computing environment activities to detect events related to a computing environment for the video game.

5. The method of claim 1, wherein associating advertisements with the events based upon the measured performance for the detected events, comprises identifying individual advertisements, each associated with a corresponding measured performance for the detected events.

6. The method of claim 1, wherein associating advertisements with the events based upon the measured performance for the detected events, comprises identifying individual advertisements, each associated with threshold occurrences of corresponding measured performance for the detected events.

7. The method of claim 1, wherein presenting the associated advertisements in association with the video game, comprises embedding the associated advertisements in a user interface for the video game.

8. The method of claim 1, wherein presenting the associated advertisements in association with the video game, comprises embedding the associated advertisements in a separate user interface from a user interface for the video game.

9. A video game data processing system comprising:
a video game;
intelligent ad placement logic coupled to the video game; and,
a plurality of ads mapped to corresponding measured performance for detectable events able to occur in the video game.

10. The system of claim 9, wherein the events comprise events selected from the group consisting of user activities, game activities and computing environment attributes.

11. The system of claim 9, wherein the video game and the intelligent ad placement logic are disposed in a host computing platform.

12. The system of claim 9, wherein the video game is disposed in a host computing platform coupled to a server computing platform hosting the intelligent ad placement logic.

13. A computer program product comprising a computer usable medium embodying computer usable program code for intelligent ad integration for video gaming the computer program product comprising:
computer usable program code for monitoring a video game supported by computing resources in order to detect events in the video game;
computer usable program code for measuring performance of the computing resources in the detected events;
computer usable program code for associating advertisements with the events based upon the measured performance for the detected events; and,
computer usable program code for presenting the associated advertisements in association with the video game.

14. The computer program product of claim 13, wherein the computer usable program code for monitoring a video game supported by computing resources in order to detect events in the video game, comprises computer usable program code for monitoring user activities to detect events related to user actions in the video game.

15. The computer program product of claim 13, wherein the computer usable program code for monitoring a video game supported by computing resources in order to detect events in the video game, comprises computer usable program code for monitoring game activities to detect events related to game actions in the video game.

16. The computer program product of claim 13, wherein the computer usable program code for monitoring a video game supported by computing resources in order to detect events in the video game, comprises computer usable program code for monitoring computing environment activities to detect events related to a computing environment for the video game.

17. The computer program product of claim 13, wherein the computer usable program code for associating advertisements with the events based upon the measured performance for the detected events, comprises computer usable program code for identifying individual advertisements, each associated with a corresponding measured performance for the detected events.

18. The computer program product of claim 13, wherein the computer usable program code for associating advertisements with the events based upon the measured performance for the detected events, comprises computer usable program code for identifying individual advertisements, each associated with threshold occurrences of corresponding measured performance for the detected events.

19. The computer program product of claim 13, wherein the computer usable program code for presenting the associated advertisements in association with the video game, comprises computer usable program code for embedding the associated advertisements in a user interface for the video game.

20. The computer program product of claim 13, wherein the computer usable program code for presenting the associated advertisements in association with the video game, comprises computer usable program code for embedding the associated advertisements in a separate user interface from a user interface for the video game.
